(19) United States
(12) Patent Application Publication
(10) Pub. No.: US 2007/0280454 A1
(43) Pub. Date: Dec. 6, 2007

(54) Signaling a Telecommunications Terminal Through a Remote System

(75) Inventors: Sandra R. Abramson, Freehold, NJ (US); Stephen M. Milton, Freehold, NJ (US)

Correspondence Address: DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/421,606

(22) Filed: Jun. 1, 2006

(51) Int. Cl. H04M 3/42

(52) U.S. Cl. 379/201.01

(57) ABSTRACT

A technique is disclosed that provides a conduit for enabling a private branch exchange, or other data-processing system, to initiate the performance of a function on a cellular telephone or other off-premises telecommunications terminal that is affiliated with the exchange. The conduit comprises a client application that resides on the off-premises terminal that observes the calling party identifier of all incoming calls. When the private branch exchange desires to initiate a function on the terminal, the exchange dials the terminal and postpends dialed digits by using dual tone multi-frequency signaling, where the dialed digits identify the particular function call and the arguments of the function. When the client application on the telecommunications terminal determines that the value of the calling party identifier is from the private branch exchange of the illustrative embodiment, the application looks for the postpended dialed digits and, upon finding them, initiates the function that corresponds to them.

### REFERENCE TO RELATED APPLICATIONS

This application incorporates herein by reference the underlying concepts, but not necessarily the nomenclature, of U.S. patent application Ser. No. 11/122866, filed on 5 May 2005, Attorney Docket 630-118US, entitled “Changing the User Interface at a Telecommunications Terminal.”

### FIELD OF THE INVENTION

The present invention relates to telecommunications in general, and, more particularly, to signaling a telecommunications terminal through a system that is remote with respect to the signaling system.

### BACKGROUND OF THE INVENTION

FIG. 1 depicts a schematic diagram of a telecommunications system in the prior art. Telecommunications system 100 comprises:
i. telecommunications network 101;
ii. private branch exchange 102;
iii. on-premises telecommunications terminals 103-1 through 103-H, wherein H is a positive integer; and
iv. network telecommunications terminals 104 and 105,
   all of which are interconnected as shown.

Telecommunications network 101 comprises the Public Switched Telephone Network, which is a complex of telecommunications equipment that is owned and operated by different entities throughout the World. In the United States of America, for example, the Public Switched Telephone Network (or “PSTN”) comprises an address space that is defined by ten digits, and, therefore, comprises 10 billion unique addresses or “telephone numbers.” The public switched telephone networks in other countries are similar.

Network 101 interconnects the other telecommunications networks, which include the enterprise network supported by private branch exchange 102. The enterprise network provides telecommunications service to telecommunications terminals 103-1 through 103-H that are “on-premises” within the enterprise area served, such as an office building or campus.

Additionally, network 101 provides telecommunications service to other telecommunications terminals, such as terminals 104 and 105. For example, terminal 105 might originate a call that routes through network 101 to private branch exchange 102 or might receive a call that routes through network 101 from exchange 102.

Private branch exchange (PBX) 102 is capable of switching incoming calls from telecommunications network 101 via one or more communications paths to one or more of on-premises terminals 103-1 through 103-H. Private branch exchange 102 is also capable of handling outgoing calls from the on-premises terminals to network 101 via one or more communications paths.

Private branch exchange 102 is also capable of forwarding an incoming call, such as from terminal 102, to a telephone number of a PBX user's “off-premises” terminal that is accessible through network 101. This type of forwarding to a terminal affiliated with exchange 102 is also known as “extending” a call because the connection to the off-premises terminal appears to exchange 102 as an additional PBX line. Exchange 102 extends the call to the off-premises terminal in addition to switching the same incoming call to an on-premises terminal within the enterprise area that exchange 102 serves. For example, for one particular user who subscribes to the enterprise network served by exchange 102, terminal 103-1 is the on-premises terminal, while terminal 104 is the off-premises terminal. Note that in system 100, there are terminals supported by network 101 that are not considered to be off-premises terminals-for example, terminal 105-because unlike terminal 104, they are not affiliated with exchange 102.

To accomplish (i) the switching of an incoming, enterprise-related call to an on-premises terminal and (ii) the extending of the call to the correct off-premises terminal, private branch exchange 102 maintains a table that correlates the off-premises telephone number to the on-premises, private branch exchange extension. Table 1 depicts a table that illustrates the correlation.

TABLEA 1
PBX Extension-to-PSTN Number Database

| On-Premises | | |
|---|---|---|
| Telecommunications | Private Branch | Telecommunications |
| Terminal | Exchange Extension | Network Number |
| 103-1 | 732-555-0102, x11 | 201-555-1236 |
| 103-2 | 732-555-0102, x12 | 908-555-3381 |
| . . . | . . . | . . . |

As an example, a first caller at terminal 105 who wishes to reach the PBX user of terminal 103-1 dials the PBX number (i.e., 732-555-0102). Private branch exchange 102 receives the incoming call and the extension number (i.e., x11) as specified by the caller. By using stored information that is similar to the information in Table 1, private branch exchange 102 determines that the call is also to be extended to off-premises telephone number 201-555-1236. This is the telephone number that is associated with off-premises terminal 104, which belongs to the PBX user of terminal 103-1. Exchange 102 then extends the call to terminal 104. The idea behind transmitting the call to both terminals 103-1 and 104 (or sometimes to terminal 104 only) is that if the PBX user is not reachable at his office phone (i.e., terminal 103-1), then possibly he is reachable at a phone that is outside of the office (i.e., terminal 104). The extending of the call to an off-premises terminal enhances the caller's experience by only requiring the caller to use a single telephone number to reach the PBX user, regardless of whether or not the PBX user is in the office.

The extending of the call in the example to terminal 104-or to any off-premises terminal, for that matter-requires that the call-control signaling for the extended call be routed through telecommunications network 101, as well as through any other intermediate network. Favorably, the signaling in routing the extended call is relatively straightforward, in that the extended call appears to be a regular, incoming call to the networks that handle the call and to the called terminal. Any additional signaling from the private branch exchange to the off-premises terminal, however, can be problematic. What is needed is a technique to provide additional signaling from a private branch exchange—or from any other data-processing system, for that matter—to an affiliated, off-premises terminal or other device that a remote system is serving, without some of the disadvantages in the prior art.

### SUMMARY OF THE INVENTION

The present invention provides a conduit that enables a private branch exchange, or other data-processing system, to initiate the performance of a function on a cellular telephone or other off-premises telecommunications terminal that is affiliated with the exchange, without some of the disadvantages in the prior art. In particular, the conduit comprises a client application that resides on the off-premises terminal that observes the calling party identifier of all incoming calls. When the private branch exchange desires to initiate a function on the terminal, the exchange dials the terminal and postpends dialed digits by using dual tone multi-frequency (DTMF) signaling, where the dialed digits identify the particular function call and, optionally, one or more arguments of the function. When the client application on the telecommunications terminal determines that the value of the calling party identifier is from the private branch exchange of the illustrative embodiment, the application looks for the postpended dialed digits and, upon finding them, initiates the function that corresponds to them.

In some embodiments of the present invention, when the client application detects the calling party identifier of the private branch exchange, the application disables the alerting mechanism on the telecommunications terminal so that the terminal's user remains unaware of the transaction going on. Some functions to be performed at the terminal, after all, might not require user interaction or awareness. Certain values of the calling party identifier might correspond to a function call and a disabling of the terminal's alerting mechanism, while other values of the identifier might correspond to a function call with no disabling of the alerting mechanism, while still other values of the identifier might not correspond to a function call at all.

The invocation of one or more functions at a telecommunications terminal through the traffic channel is advantageous in that it involves no modifications to any equipment between the private branch exchange and the target telecommunications terminal. Instead, in the example of a cellular network, the serving mobile switching center first receives what appears to be a standard incoming call from the private branch exchange and then directs the call to the target cell phone. When the call is answered by the cell phone, the private branch exchange proceeds to then signal the terminal, via the traffic channel, to perform one or more functions. The signaling is transparent to the mobile switching center because it occurs on the traffic channel, instead of on the cellular network's control or signaling channels.

The illustrative embodiment of the present invention comprises: receiving an indication that a first telecommunications terminal perform a first function; and transmitting, to the first telecommunications terminal: i) a first calling party identifier, and ii) a first series of dialed digits that identifies the first function.

### BRIEF DESCRIPTION OF THE DRAWINGS

FIG. 1 depicts a schematic diagram of telecommunications system 100 in the prior art.

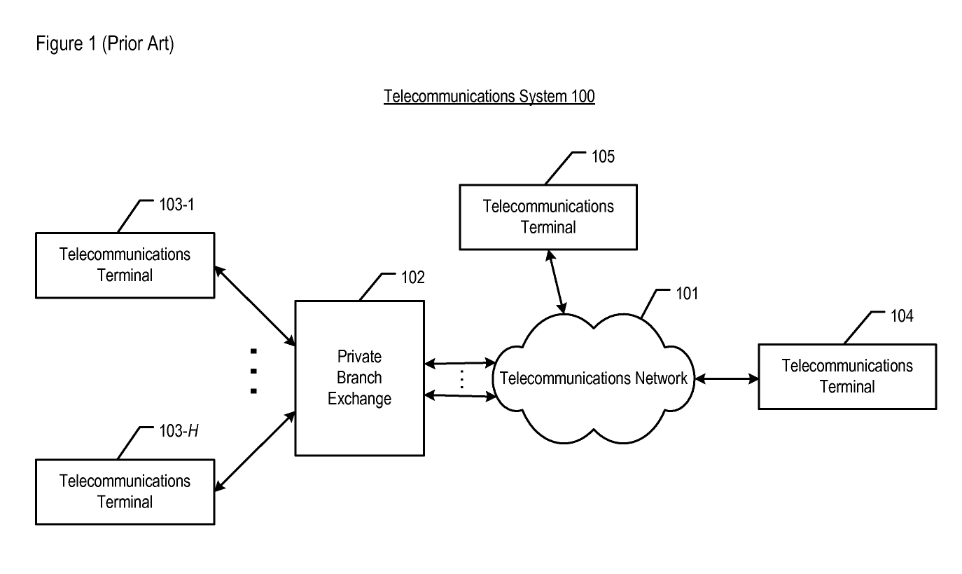

FIG. 2 depicts a schematic diagram of telecommunications system 200, in accordance with the illustrative embodiment of the present invention.

FIG. 3 depicts a block diagram of the salient components of private branch exchange 202, which is a part of system 200.

FIG. 4 depicts a block diagram of the salient components of off-premises telecommunications terminal 206, which is a part of system 200.

FIG. 5 depicts a flowchart of the operation of exchange 202 when handling a function that is intended for a telecommunications terminal to perform, in accordance with the illustrative embodiment of the present invention.

FIG. 6 depicts flowcharts of the operation of terminal 206, when handling one or more incoming calls, in accordance with the illustrative embodiment of the present invention.

FIG. 7 depicts a flowchart of the salient subtasks of task 603, in which terminal 206 processes a function call from exchange 202.

### DETAILED DESCRIPTION

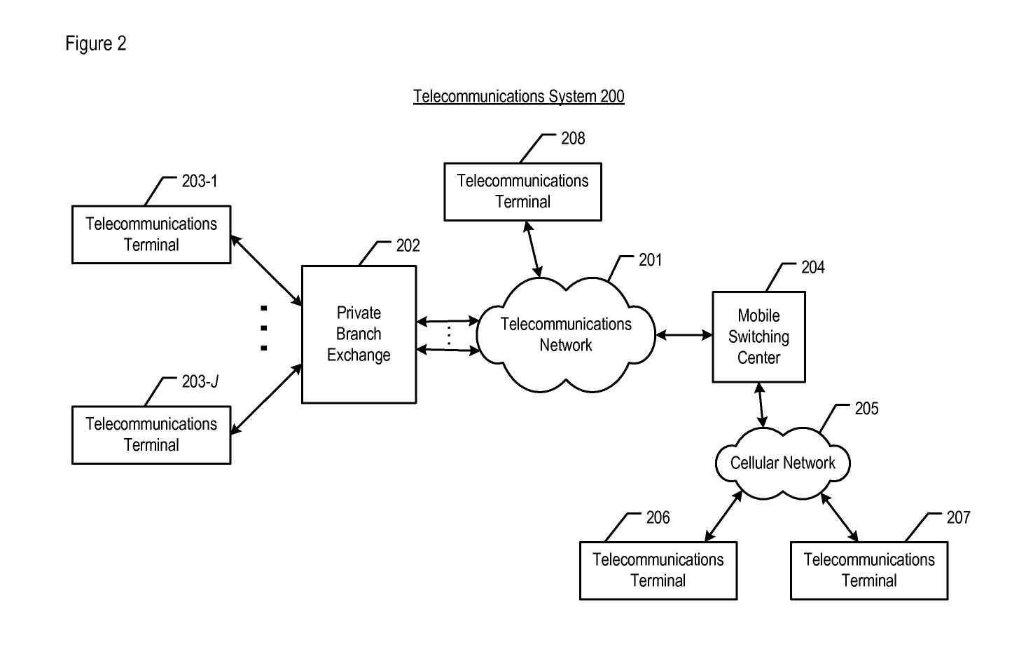

FIG. 2 depicts a schematic diagram of a telecommunications system, in accordance with the illustrative embodiment of the present invention. Telecommunications system 200 comprises:
i. telecommunications network 201;
ii. private branch exchange 202;
iii. on-premises telecommunications terminals 203-1 through 203-J, wherein J is a positive integer;
iv. mobile switching center 204;
v. cellular network 205;
vi. cellular telecommunications terminals 206 and 207; and
vii. network telecommunications terminal 208,
all of which are interconnected as shown.

Telecommunications network 201 is one of multiple networks that constitute telecommunications system 200. Telecommunications network 201 comprises the Public Switched Telephone Network (PSTN), in accordance with the illustrative embodiment. Through Public Switched Telephone Network infrastructure, as well as through other switching and transmission infrastructure, network 201 provides telecommunications service to terminals such as network telecommunications terminal 208. As those who are skilled in the art will appreciate, in some alternative embodiments, network 201 can comprise a different group of networks than depicted, such as an Internet Protocol-based network, an Ethernet network, and so forth.

Network 201 interconnects the other telecommunications networks, which include: (i) the enterprise network supported by private branch exchange 202, and (ii) cellular network 205 supported by mobile switching center 204. The enterprise network supported by private branch exchange 202 provides telecommunications service to one or more telecommunications terminals, namely terminals 203-1 through 203-J, within the enterprise area served, such as an office building or campus. Cellular network 205, which is supported by mobile switching center 204, provides telecommunications service to one or more cellular telecommunications terminals, including cellular telecommunications terminals 206 and 207.

FIG. 2 also depicts multiple telecommunications terminals of various types. Those terminal types include Plain Old Telephone Service (POTS) terminals, as exemplified by terminal 208; office desksets, as exemplified by terminals 203-1 through 203-J; cell phones, as exemplified by terminals 206 and 207; laptops with wireless network adapters; and so forth. As those who are skilled in the art will appreciate, the present invention is also applicable to other combinations of terminals than what FIG. 2 depicts.

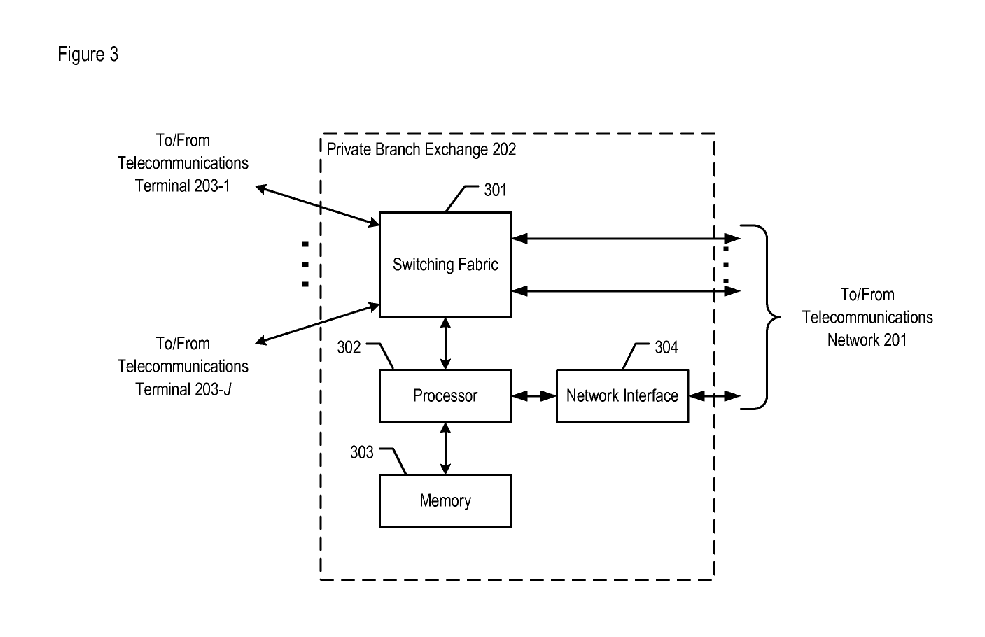

Private branch exchange 202 is a data-processing system, the salient components of which are described below and with respect to FIG. 3. Private branch exchange 202 is capable of switching incoming calls (e.g., from terminal 208, etc.) from network 201 via one or more communications paths to on-premises terminals 203-1 through 203-J. Exchange 202 is also capable of handling outgoing calls from the on-premises terminals to network 201 via one or more communications paths.

Private branch exchange 202 is also capable of extending an incoming call (e.g., from terminal 208, etc.) to a telephone number of an off-premises terminal. An “off-premises” terminal is a terminal that is accessible through network 201 while still being affiliated with exchange 202 as an extension to exchange 202's enterprise network. For pedagogical purposes, telecommunications terminals 206 and 207 are the off-premises terminals in telecommunications system 200. Exchange 202 is capable of extending the incoming call to the intended off-premises terminal in addition to or independently of switching the same incoming call to an on-premises terminal within the enterprise area that exchange 202 serves.

Private branch exchange 202 is connected to telecommunications systems that are present in network 201 via communications paths that comprise Integrated Services Digital Network (ISDN) trunks, as are known in the art. As those who are skilled in the art will appreciate, other types of communications paths might connect exchange 202 to network 201. For example, exchange 202 might receive at least some of the incoming calls via the Session Initiation Protocol over an Internet Protocol-based network.

FIG. 2 depicts on-premises terminals 203-1 through 203-J and off-premises terminals 206 and 207. It will be clear to those skilled in the art, however, after reading this disclosure, how to make and use alternative embodiments of the present invention in which private branch exchange 202 provides telecommunications service to a different number of on-premises terminals and a different number of off-premises terminals than those depicted.

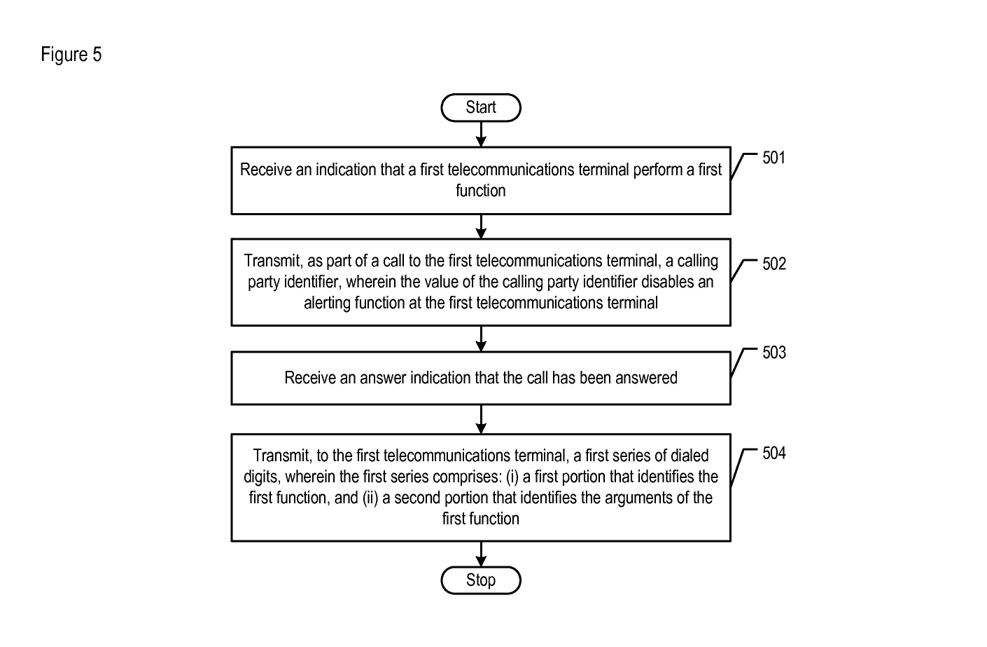

Private branch exchange 202 is also capable of performing the tasks described below and with respect to FIG. 5, in accordance with the illustrative embodiment. For example, exchange 202 can signal to an off-premises terminal to perform a function. Such a function can be to change one or more aspects of the user interface of the off-premises terminal, as described in U.S. patent application Ser. No. 11/122866 (Attorney Docket No. 630-118us), filed 5 May 2005, the underlying concepts of which are incorporated herein by reference.

It will be clear to those skilled in the art, after reading this disclosure, how to make and use private branch exchange 202. Moreover, as those who are skilled in the art will appreciate, there can be alternative embodiments of the present invention in which a switch, contact center, or other type of data-processing system than a private branch exchange performs the described tasks. As with exchange 202, the data processing systems in those alternative embodiments can inter-operate in and with a variety of different networks. In other words, the present invention is equally well suited for implementation in public and private telecommunications systems that are wireline or wireless-based, and in accordance with various protocols.

Mobile switching center 204 is capable of switching incoming calls from network 201 to registered cellular-capable terminals, such as terminals 206 and 207. Mobile switching center 204 is also capable of handling outgoing calls from cellular-capable terminals to network 201. Switching center 204 communicates with terminals 206 and 207 via one or more radio base stations in cellular network 205, in well-known fashion. It will be clear to those skilled in the art how to make and use mobile switching center 204.

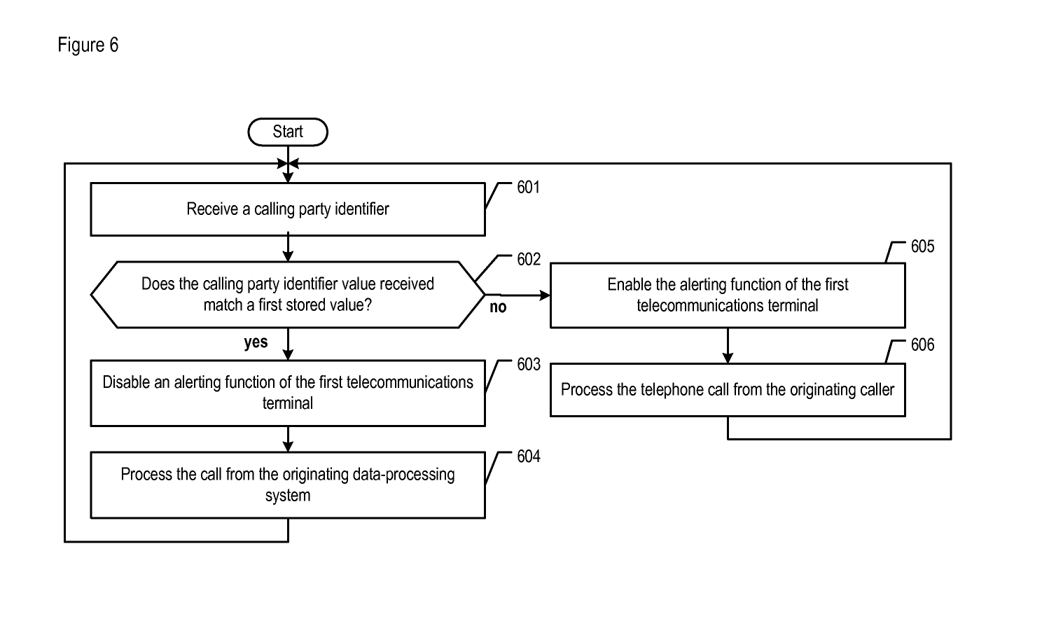

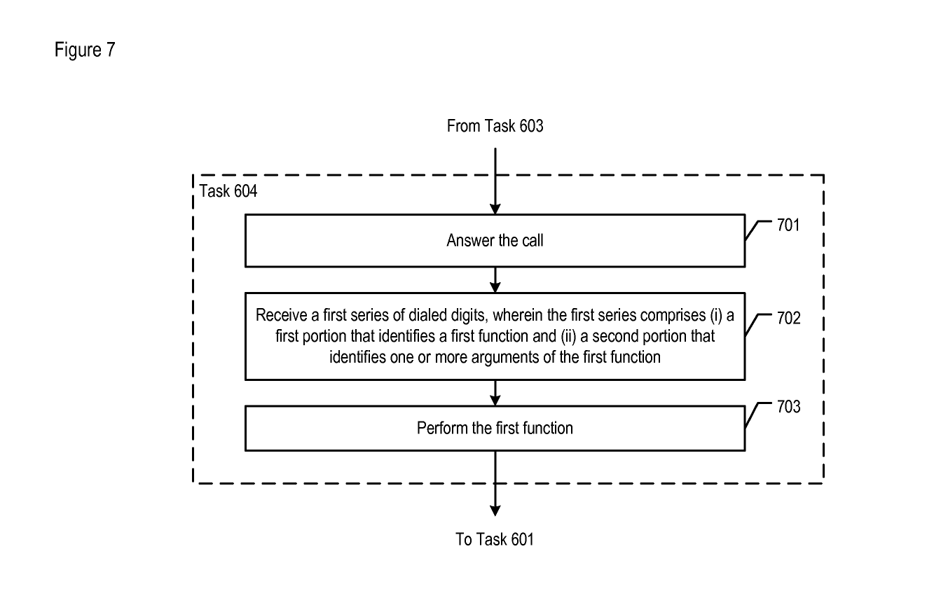

Off-premises telecommunications terminals 206 and 207 are capable of originating and receiving calls in well-known fashion. Some of the originated or received calls are routed through private branch exchange 202, while some are not. Terminals 206 and 207 are also capable of performing the tasks described below and with respect to FIGS. 6 and 7, in accordance with the illustrative embodiment. For example, each off-premises terminal is capable of receiving signaling from exchange 202 to perform a specified function, as well as being capable of performing that function. Terminals 206 and 207 in the illustrative embodiment are cellular phones. As those who are skilled in the art will appreciate, other types of terminals (e.g., softphones, ISDN terminals, etc.) can be off-premises terminals in telecommunications system 200. It will be clear to those skilled in the art, after reading this specification, how to make and use off-premises terminals 206 and 207.

FIG. 3 depicts a block diagram of the salient components of private branch exchange 202 in accordance with the illustrative embodiment of the present invention. Private branch exchange 202 comprises: switching fabric 301, processor 302, memory 303, and network interface 304, interconnected as shown. As those who are skilled in the art will appreciate, in some alternative embodiments, the salient components can be arranged differently than depicted.

Switching fabric 301 is capable of switching calls between on premises terminals (e.g., terminals 203-1 through 203-1, etc.), and terminals that are accessible through network 201. In addition, switching fabric 301 is capable of performing the tasks described below and with respect to FIG. 5, under the direction of processor 302. It will be clear to those skilled in the art how to make and use switching fabric 301.

Processor 302 is a general-purpose processor that is capable of receiving called-related data from switching fabric 301, of reading data from and writing data to memory 303, and of executing the tasks described below and with respect to FIG. 5. In some alternative embodiments of the present invention, processor 302 might be a special-purpose processor. In either case, it will be clear to those skilled in the art, after reading this disclosure, how to make and use processor 302.

Memory 303 is a device that stores the instructions and data used by processor 302. Memory 303 stores the PBX on-premises extension and affiliated off-premises telephone number for each PBX user, which are shown in Table 1. Memory 303 also stores, for each off-premises terminal that is affiliated with exchange 202, the function-related information and values that are described below and with respect to FIGS. 5 through 7. It will be clear to those skilled in the art, after reading this disclosure, how to make and use memory 303.

Network interface 304 is capable of routing control-related signals between processor 302 and off-premises terminals 206 and 207, in accordance with the illustrative embodiment of the present invention. In accordance with the illustrative embodiment, network interface 304 is separate from switching fabric 301 and handles control signals transmitted on signal paths that are separate from the voice paths. In some alternative embodiments, network interface 304 is integrated with switching fabric 301 and handles control signals that are present in the voice paths. It will be clear to those skilled in the art how to make and use network interface 304.

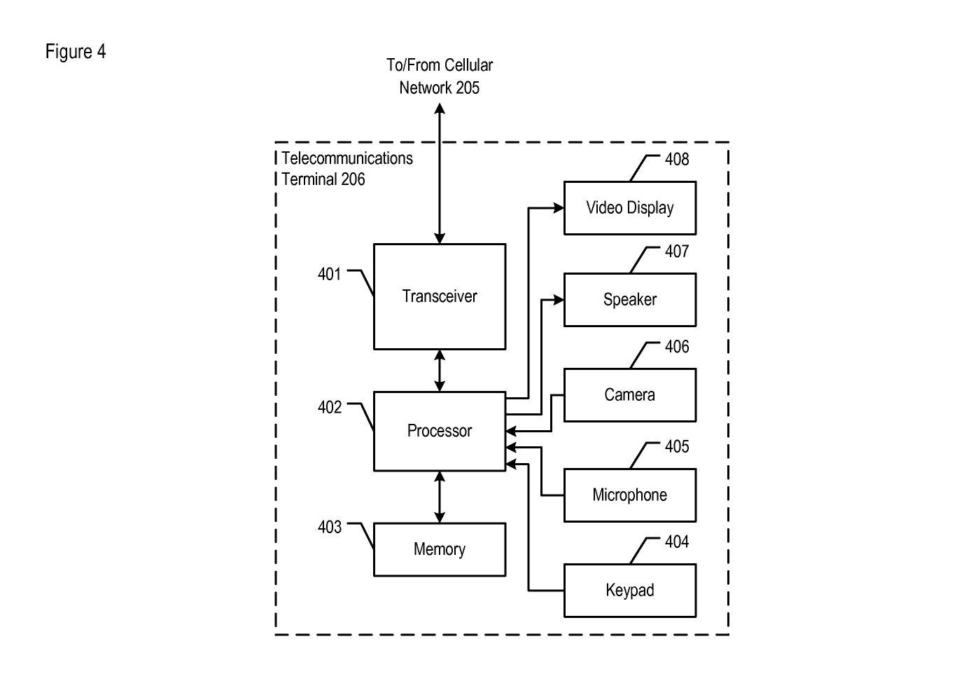

FIG. 4 depicts a block diagram of the salient components of off-premises telecommunications terminal 206, in accordance with the illustrative embodiment of the present invention. Although cellular terminal 206 is the terminal represented in FIG. 4, it will be clear to those skilled in the art, after reading this disclosure, how to make and use other off-premises terminals (e.g., terminal 207, etc.) according to what is described with respect to FIG. 4. Telecommunications terminal 206 comprises: transceiver 401, processor 402, memory 403, keypad 404, microphone 405, camera 406, speaker 407, and video display 408, interconnected as shown. As those who are skilled in the art will appreciate, in some alternative embodiments, the salient components can be arranged differently than depicted or can be a different set of components than depicted.

Transceiver 401 comprises a receiving part and a transmitting part. The receiving part receives signals from cellular network 205, and forwards the information encoded in the signals to processor 402, in well-known fashion. The transmitting part receives information from processor 402, and outputs signals that encode this information to cellular network 205, in well-known fashion. It will be clear to those skilled in the art how to make and use transceiver 401.

Processor 402 is a general-purpose processor that is capable of: receiving information from transceiver 401, keypad 404, microphone 405, and camera 406; reading data from and writing data into memory 403; executing the tasks described below and with respect to FIGS. 6 and 7; and transmitting information to transceiver 401, speaker 407, and video display 408. In some alternative embodiments of the present invention, processor 402 might be a special-purpose processor. In either case, it will be clear to those skilled in the art, after reading this disclosure, how to make and use processor 402.

Memory 403 is a device that stores the instructions and data used by processor 402. For example, memory 403 stores the calling party identifier values and function-related values that are described below and with respect to FIGS. 5 through 7. It will be clear to those skilled in the art how to make and use memory 403.

Keypad 404 is a character and user-selection input device as is well known in the art that receives input from a user and transmits keypad signals representing that input. Keypad 404 comprises fixed function keys and soft keys, as are known in the art. It will be clear to those skilled in the art how to make and use keypad 404.

Microphone 405 converts acoustic signals (e.g., from the end user, etc.) into electromagnetic signals, and speaker 407 converts electromagnetic signals into acoustic signals (e.g., intended for the end user, etc.), both in well-known fashion.

Camera 406 converts visual signals into electromagnetic signals, and video display 408 converts electromagnetic signals into visual signals (e.g., intended for the end user, etc.), both in well-known fashion.

FIG. 5 depicts a flowchart of the operation of private branch exchange 202, a data-processing system, when handling a function that is intended for a telecommunications terminal to perform, in accordance with the illustrative embodiment of the present invention. As those who are skilled in the art will appreciate, in some alternative embodiments, the tasks described with respect to FIG. 5 can apply to other data-processing systems. Furthermore, it will also be appreciated that private branch exchange 202 can handle calls that are intended for more than one telecommunications terminal simultaneously by concurrently applying the described tasks to each terminal. It will be clear to those skilled in the art which tasks depicted in FIG. 5 can be performed simultaneously or in a different order than that depicted.

In the example depicted, off-premises terminal 206 is the intended, telecommunications terminal that is referred to in the described tasks. As those who are skilled in the art will appreciate, however, the tasks described with respect to FIG. 5 can apply to other off-premises telecommunications terminal as well.

At task 501, exchange 202 receives an indication that a first telecommunications terminal, in this case terminal 206, is to perform one or more functions as specified by exchange 202. Performance of a function by the terminal is intended to affect one or more properties at the terminal; the properties include, but are not limited to, one or more of the following:
i. how calls are presented to the user;
ii. the treatment that a user can apply to calls;
iii. the call-dependent features available to the user;
iv. the call-independent features available to the user;
v. how a user invokes the features;
vi. the number of accessible call appearances;
vii. the functions that are assigned to the terminal's soft keys;
viii. the menus available to the user;
ix. how the user accesses the menus;
x. the speed dialing list that is in effect; and
xi. the operation of one or more of keypad 404, microphone 405, camera 406, speaker 407, and video display 408.

At task 502, exchange 202 transmits a calling party identifier to terminal 206, wherein the calling party identifier serves to identify exchange 202 or some aspect of exchange 202 that is related to sending a function call to the terminal. In accordance with the illustrative embodiment, exchange 202 transmits the calling party identifier as part of what appears to be—that is, to mobile switching center 204-a call to terminal 206. Exchange 202 can transmit the calling party identifier, for example, via the Automatic Number Identification (ANI) procedure, which is well-known in the art. In addition to indicating that a function call is to follow, in some embodiments, the value of the calling party identifier is intended to disable an alerting function at terminal 206 so that its user remains unaware of the function transaction that is taking place.

At task 503, exchange 202 receives, in well-known fashion, an answer indication that the call has been answered by terminal 206. In other words, terminal 206 has received the function call from exchange 202 and has accepted it.

At task 504, exchange 202 proceeds to transmit, to terminal 206, a first series of dialed digits in well-known fashion. In accordance with the illustrative embodiment, exchange 202 transmits the dialed digits via one or more dual tone multi-frequency signals, as are known in the art. In some alternative embodiments, exchange 202 transmits the dialed digits as part of an encoded message.

In accordance with the illustrative embodiment, the first series of dialed digits comprises:
i. a first portion that identifies the first function, and
ii. a second portion that identifies the arguments of the first function.

FIGS. 6 and 7 depict flowcharts of the operation of telecommunications terminal 206, when handling one or more incoming calls, in accordance with the illustrative embodiment of the present invention. As those who are skilled in the art will appreciate, the tasks described with respect to FIGS. 6 and 7 can apply to other off-premises telecommunications terminals such as terminal 207. It will be clear to those skilled in the art which tasks depicted in FIGS. 6 and 7 can be performed simultaneously or in a different order than that depicted.

At task 601, terminal 206 receives a calling party identifier, in well-known fashion, as part of an incoming call.

At task 602, in accordance with the illustrative embodiment, terminal 206 checks if the received calling party identifier matches with a value that is stored in memory 303. If there is a match, signifying that a function call is to follow, task execution proceeds to task 603. If there is no match, signifying that a conventional telephone call is being received, task execution proceeds to task 605.

At task 603, terminal 206 disables an alerting function. For example, if terminal 206 is currently programmed to play a particular ringtone to alert its user of an incoming call, then the ringtone is disabled. Likewise, if the terminal is programmed to vibrate to alert of an incoming call, then the vibration is disabled. Terminal 206 disables the alerting function because the incoming “call” is not really a call in the end-user sense, but a mechanism with which to signal the terminal that a function call is to follow.

In some alternative embodiments, terminal 206 does not disable the alerting function or disables the alerting function for only some of the calling party identifier values associated with function calls.

At task 604, terminal 206 processes the call from the originating data-processing system—in this case, private branch exchange 202—in accordance with the illustrative embodiment of the present invention. The details of task 604 are described below and with respect to FIG. 7. Task execution then returns to task 601.

At task 605, in response to receiving a non-matching calling party identifier, terminal 206 re-enables the alerting function that had been disabled at task 603.

At task 606, terminal 206 processes the telephone call from the originating caller in well-known fashion. Task execution then returns to task 601.

FIG. 7 depicts a flowchart of the salient subtasks of task 604, in which terminal 206 processes the call from the originating data-processing system.

At task 701, terminal 206 answers the call in well-known fashion. This comprises sending an answer indication to mobile switching center 204, which then sends the answer indication to exchange 202.

At task 702, terminal 206 receives a first series of dialed digits from exchange 202. In accordance with the illustrative embodiment, terminal 206 receives the dialed digits via one or more dual tone multi-frequency signals, as are known in the art. In some alternative embodiments, terminal 206 receives the dialed digits as part of an encoded message. In accordance with the illustrative embodiment, the first series of dialed digits comprises:

i. a first portion that identifies a first function, and
ii. a second portion that identifies the arguments of the first function.

Terminal 206 knows that the dialed digits identify at least a function because of the value of the calling party identifier received at task 601. Terminal 206 decodes the dialed digits to determine the specific function that needs to be performed and, if present, the specific arguments to the function that need to be considered.

At task 703, terminal 206 performs the identified first function, in accordance with the illustrative embodiment. Examples of functions and their intended effects are listed above and with respect to task 501. A function might have the effect of changing an aspect of the user interface, of manipulating or storing one or more values in memory, and so forth. Changing the user interface might include affecting one or more of devices such as keypad 404, microphone 405, camera 406, speaker 407, and video display 408, as well as affecting the part of the database that is related to call information and how calls are to be handled. Values that are changed or stored in memory might include the specific calling party identifier values that correspond to the function-invoking, data-processing systems of the illustrative embodiment. Those values might also constitute the computer programs that correspond to the functions themselves, as well as information on how to handle the execution of the functions with their arguments. Task execution then proceeds to task 601.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A method comprising:
receiving an indication that a first telecommunications terminal perform a first function; and
transmitting, to said first telecommunications terminal:
i) a first calling party identifier, and
ii) a first series of dialed digits that identifies said first function.

2. The method of claim 1 wherein said first calling party identifier identifies the data-processing system that transmits, to said first telecommunications terminal, said first calling party identifier.

3. The method of claim 2 further comprising disabling, based on the value of said first calling party identifier, an alerting function at said first telecommunications terminal.

4. The method of claim 1 wherein a first portion of said first series of dialed digits identifies said first function.

5. The method of claim 4 wherein said first portion of said first series of dialed digits is transmitted to said first telecommunications terminal as one or more dual tone multi-frequency signals.

6. The method of claim 4 wherein said first portion of said first series of dialed digits is transmitted to said first telecommunications terminal as part of an encoded message.

7. The method of claim 1 wherein a second portion of said first series of dialed digits identifies one or more arguments of said first function.

8. A method comprising:
receiving, at a first telecommunications terminal:
i) a first calling party identifier, and
ii) a first series of dialed digits; and
performing a first function, based on (i) the value of said first calling party identifier and (ii) said first series of dialed digits.

9. The method of claim 8 further comprising disabling, based on the value of said first calling party identifier, an alerting function at said first telecommunications terminal.

10. The method of claim 8 wherein a first portion of said first series of dialed digits identifies said first function.

11. The method of claim 10 wherein said first portion of said first series of dialed digits is received at said first telecommunications terminal as one or more dual tone multi-frequency signals.

12. The method of claim 10 wherein said first portion of said first series of dialed digits is received at said first telecommunications terminal as part of an encoded message.

13. The method of claim 8 wherein a second portion of said first series of dialed digits identifies one or more arguments of said first function.

14. The method of claim 8 wherein the performing of said first function is also based on said first calling party identifier and first series of dialed digits matching values that are stored at said first telecommunications terminal.

15. The method of claim 14 further comprising:
receiving, at said first telecommunications terminal, a second calling party identifier; and
storing, based on the value of said second calling party identifier, said values at said first telecommunications terminal.

16. A method comprising:
receiving, at a first telecommunications terminal, a first calling party identifier; and
disabling, based on the value of said first calling party identifier, an alerting function at said first telecommunications terminal.

17. The method of claim 16 wherein said alerting function remains disabled at least until said first telecommunications terminal receives a second calling party identifier whose value is different from that of said first calling party identifier.

18. The method of claim 17 further comprising:
receiving a first series of dialed digits; and
performing a first function, based on (i) the value of said first calling party identifier and (ii) said first series of dialed digits.

19. The method of claim 18 wherein a first portion of said first series of dialed digits identifies said first function.

20. The method of claim 19 wherein said first portion of said first series of dialed digits is received at said first telecommunications terminal as one or more dual tone multi-frequency signals.
